(19) United States
(12) Patent Application Publication
(10) Pub. No.: US 2007/0178368 A1
(43) Pub. Date: Aug. 2, 2007

(54) Button-cell battery chamber

(76) Inventors: Hui-Ming Wu, Taipei (TW); Hui-Min Wu, Taipei (TW); Pi-Hsia Lee, Taipei (TW)

Correspondence Address: LEONG C LEI, PMB # 1008, 1867 YGNACIO VALLEY ROAD, WALNUT CREEK, CA, 94598, US

(21) Appl. No.: 11/340,433

(22) Filed: Jan. 27, 2006

(51) Int. Cl. H01M 2/10

(52) U.S. Cl. 429/97; 429/99; 429/100

(57) ABSTRACT

A battery chamber of button-cell batteries for consumer electronic devices is provided herein, which mainly contains a top member and a bottom member joined together to form a number of cell rooms for the accommodation of the button-cell batteries. A number of conduction plates covers the top and bottom of the cell rooms and electrically connects the button-cell batteries into a series connection. The thickness of the top and bottom members is roughly one half of a standard button-cell battery. The top and bottom members can be easily pried open for the installation and removal of the button-cell batteries.

### BACKGROUND OF THE INVENTION

(a) Technical Field of the Invention

The present invention generally relates to the accommodation of batteries, and more particularly to a battery chamber for housing button-cell batteries.

(b) Description of the Prior Art

As consumer electronic devices are continuously driven for smaller form factors while incorporating more functionality, the design of the battery systems of these consumer electronic devices becomes a critical issue in order to accommodate a required number of standard batteries in a limited space.

Most of the consumer electronic devices utilize miniature batteries such as the so-called button-cell batteries. As shown in FIG. 1, the button-cell batteries 50 are usually positioned in battery seats (not numbered) formed by the circuit board and a number of thin conduction plates 30. The conduction plates 30 and some electrical contacts (not numbered) on the circuit board electrically connect the button-cell batteries 50 into a series connection so as to provide the required electricity to the consumer electronic device.

The major shortcoming of the conventional approach is that the installation and replacement of the button-cell batteries are rather difficult, as the batteries can only be inserted and removed from the narrow gap between the conduction plates and the circuit board.

### SUMMARY OF THE INVENTION

The primary purpose of the present invention is to provides a battery chamber for button-cell batteries to facilitate their installation and replacement without taking up extraneous space.

The battery chamber of the present invention mainly contains a top member and a bottom member joined together to form a number of cell rooms for the accommodation of the button-cell batteries. A number of conduction plates covers the top and bottom sides of the cell rooms and electrically connects the button-cell batteries into a series connection.

The thickness of the top and bottom members is roughly one half of a standard button-cell battery and the battery chamber therefore takes up no extraneous space than what is absolutely required. The top and bottom members can be easily pried open for the installation and removal of the button-cell batteries.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view showing a conventional approach for housing button-cell batteries.

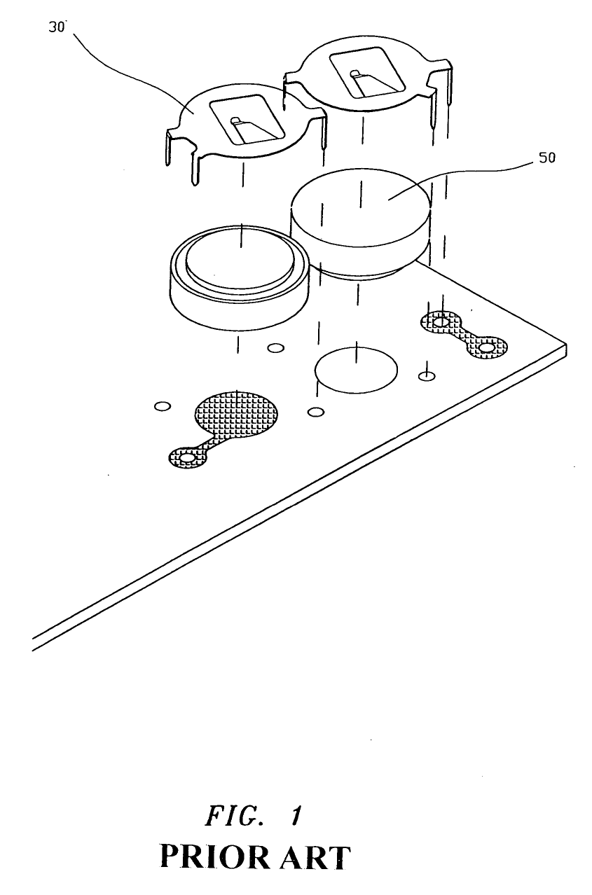

FIG. 2 is a perspective exploded view showing the various components of a battery chamber according to a first embodiment of the present invention.

FIG. 3 is a perspective view showing the assembly of the battery chamber of FIG. 2.

FIG. 4 is a sectional view showing the battery chamber of FIG. 2 installed on a circuit board.

FIG. 5 is a perspective view showing another approach of installing the battery chamber of FIG. 2 on a circuit board.

FIG. 6 is a sectional view showing the battery chamber of FIG. 5.

FIG. 7 is a perspective view showing a battery chamber according to a second embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

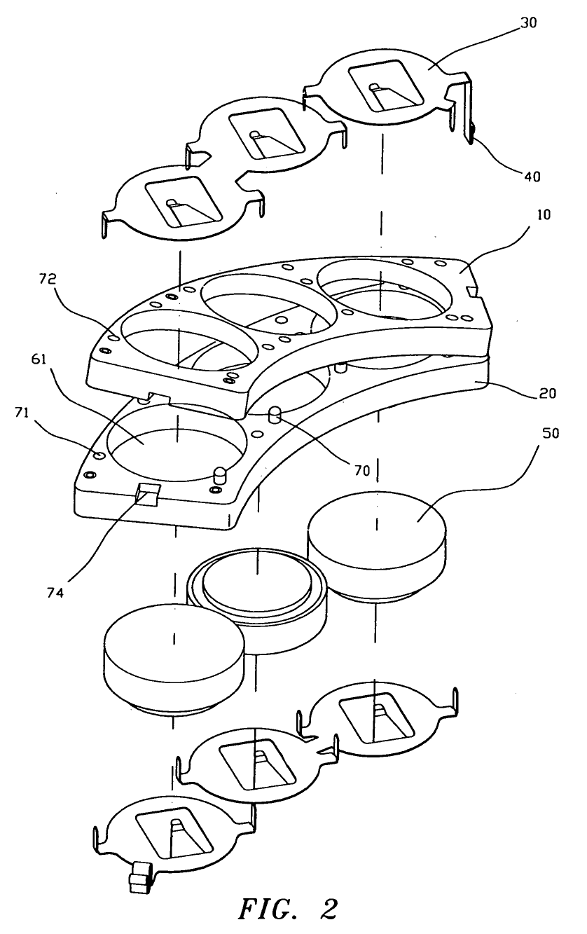

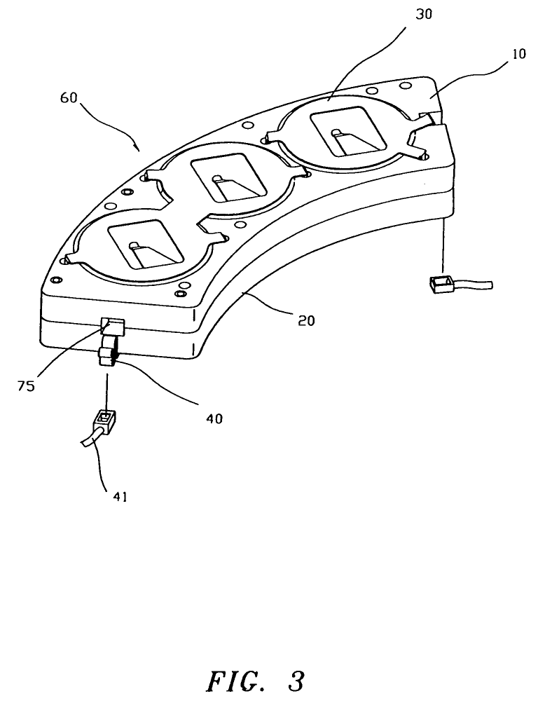

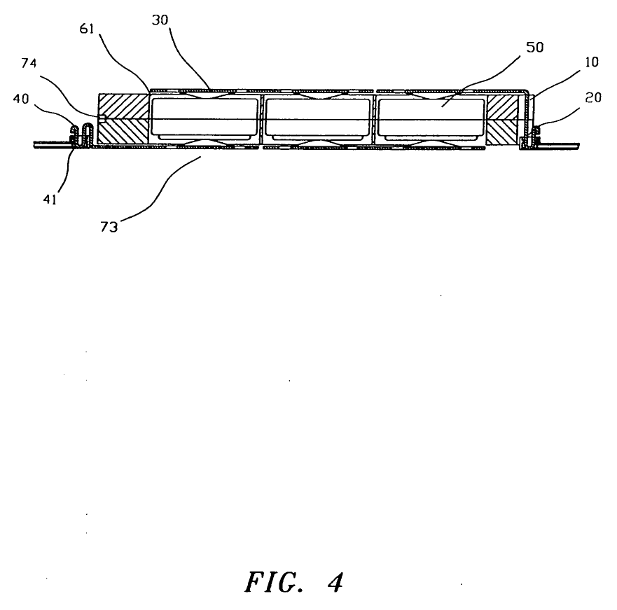

Please refer to FIGS. 2 to 4. As illustrated, a button-cell battery chamber 60 according to a first embodiment of the present invention mainly contains a top member 10, a bottom member 20, and a number of conduction plates 30.

The top and bottom members 10 and 20 have corresponding shapes and dimensions, and their thickness is roughly one half of a standard button-cell battery. There are a number of pins 70 and pin holes 71 provided on a bottom surface of the top member 10 and a top surface of the bottom member 20 respectively so as to join the top and bottom members 10 and 20 together. There are also a number of positioning holes 72 provided on a top surface of the top member 10 and a bottom surface of the bottom member 20 respectively, for the installation of the conduction plates 30. The top and bottom members 10 and 20 have a number of corresponding through holes penetrating from their top surfaces to the bottom surfaces so that, when the top and bottom member 10 and 20 are jointed together, these through holes jointly form a number of cell rooms 61 for the accommodation of the button-cell batteries 50.

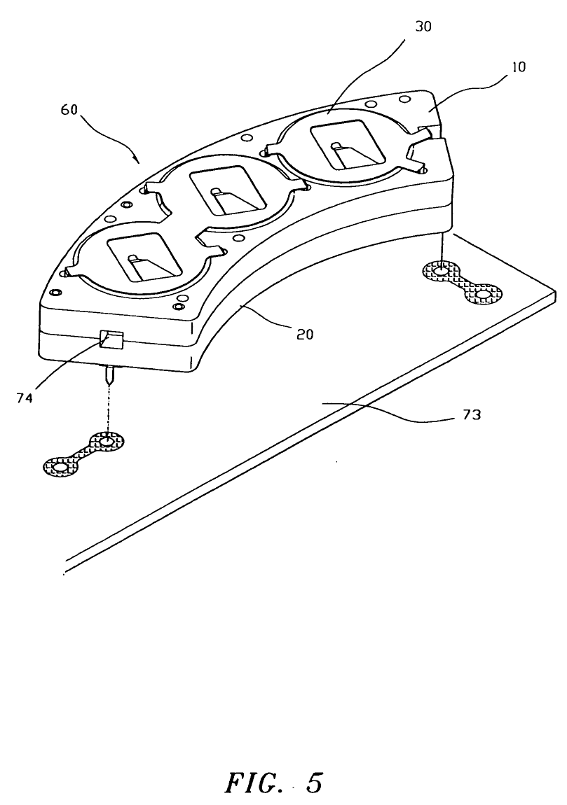

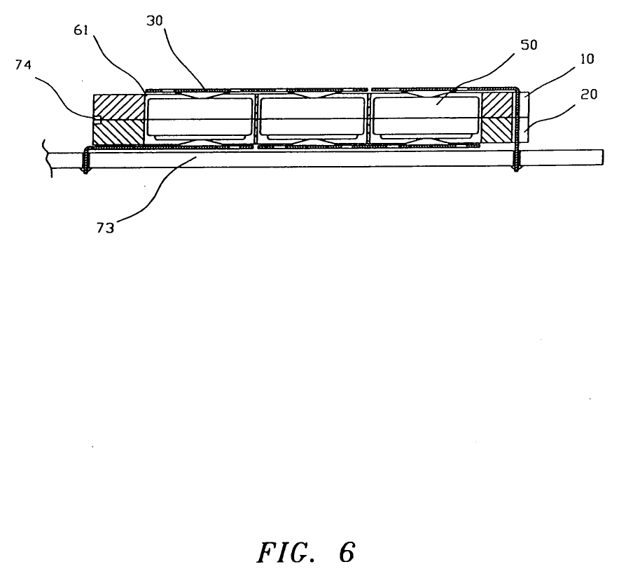

Please note that when the batteries 50 are placed in the cell rooms 61, their polarities are interleaved. The conduction plates 30 provided on the top surface and the bottom surface of the battery chamber 60 are connected appropriately so that the batteries 50 are electrically connected into a series connection. One conduction plate 30 on the top surface and another conduction plate 30 on the bottom surface next to the opposite side surfaces of battery chamber 60 are extended vertically to form connectors 40 respectively. The connectors 40 are plugged into sockets 41 extended from a circuit board 73 so that the electricity of the batteries 50 is provided to the components on the circuit board 73. As shown in FIGS. 5 and 6, the connectors 40 of the battery chamber 60 can also be directly plugged into appropriate electrical contacts configured on the circuit board 73, instead of going through the sockets 41.

There is a notch 74 on a side surface of the battery chamber 60 formed by two small dents on the corresponding side edges of the top and bottom members 10 and 20 respectively. The notch 74 is used to pry and separate the top member 10 from the bottom member 20 so as to install or remove the batteries 50 into or from the cell rooms 61.

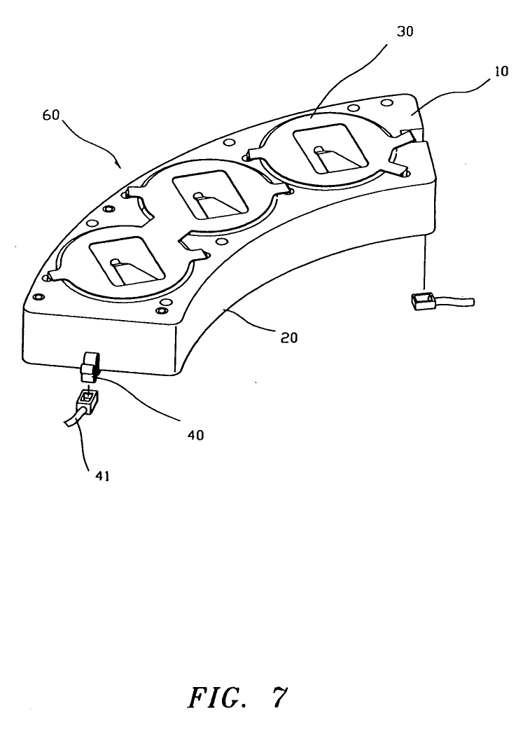

As shown in FIG. 7 which depicts a second embodiment of the present invention, the battery chamber 60 can be made of a single body member, instead of using the top and bottom members 10 and 20 to form the battery chamber 60. By using the sockets 41 for electrical connection, the battery chamber 60 can be installed or removed in its entirety.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A battery chamber for a plurality of button-cell batteries, comprising a top member, a bottom member, and a plurality of conduction plates; wherein
a plurality of pins and pin holes are provided on a bottom surface of said top member and a top surface of said bottom member respectively with which said top and bottom members are joined together;
a plurality of positioning holes are provided on a top surface of said top member and a bottom surface of said bottom member respectively for the installation of said conduction plates;
said top and bottom members have a plurality of corresponding through holes penetrating from their top surfaces to the bottom surfaces so that, when said top and bottom member are jointed together, said through holes jointly form a plurality of cell rooms for the accommodation of said button-cell batteries;
said conduction plates are connected appropriately so that said button-cell batteries, whose polarities are interleaved when placed in said cell rooms, are electrically connected into a series connection;
a plurality of connectors are extended form said conduction plates respectively for establishing electrical contact with a circuit board; and
a notch on a side surface of said battery chamber is provided to pry and separate said top and bottom members for installing and removing said button-cell batteries.

2. The battery chamber according to claim 1, wherein said top and bottom members are integral parts of a single body member of said battery chamber.

3. The battery chamber according to claim 1, wherein said connectors of said battery chamber are directly plugged into appropriate electrical contacts of said circuit board.
